(19) United States
(12) Patent Application Publication
(10) Pub. No.: US 2023/0283062 A1
(43) Pub. Date: Sep. 7, 2023

(54) CIRCUIT PROTECTION DEVICE TRIP DETECTOR

(71) Applicant: Kinexit Ltd, Southport (GB)

(72) Inventor: Thomas Owen Hutchinson, Southport (GB)

(73) Assignee: Kinexit Ltd, Southport (GB)

(21) Appl. No.: 18/014,136

(22) PCT Filed: Jun. 30, 2021
(86) PCT No.: PCT/GB2021/051662

§ 371 Date: Dec. 30, 2022

(30) Foreign Application Priority Data
Jun. 30, 2020 (GB) 2010013.7

(51) Int. Cl. H02H 3/08; G01S 17/08; H02H 1/00; H02J 9/06

(52) U.S. Cl. CPC H02H 3/08; G01S 17/08; H02H 1/0007; H02J 9/061

(57) ABSTRACT

A device (100) for monitoring the status of breakers (20) within a consumer unit (10). The device (100) uses a non-contact, optical sensor (104), such as an IR break-beam sensor (106, 108), or an optical time-of-flight sensor (106, 108) to monitor the positions of the toggle switches (22) on the breakers (20). In the event that one or more of the switches moves to an “off” position (22), an alarm is triggered, such as by sending an SMS message to a user, to alert them of the fact. The device (100) also monitors the consumer unit's power status (1020) and can warn in the event of a power outage of a master isolator or RCD trip. A UPS (1030, 1032, 1034) is suitably provided to enable the device to continue working during a mains power failure.

This invention relates to circuit protection device trip detectors.

Consumer units, and in particular, domestic consumer units, are generally located in relatively inaccessible areas and/or are rarely checked. A consumer unit is an arrangement whereby incoming mains power, e.g. from “meter tails”, is split into discrete circuits for providing electrical power to respective loads. In a typical domestic consumer unit, there will be several “ways”—one corresponding to each circuit, for example, “downstairs sockets”, “upstairs sockets”, “downstairs lights”, “upstairs lights”, “garage”, “oven”, “shower”, etc. The reason for dividing the incoming power into separate circuits thus is to enable different types of circuit protection devices to be used for each circuit, and because each circuit will have different nominal current ratings depending on the type of wiring used and the anticipated loads. Another advantage of dividing the incoming power into discrete circuits is that a failure on one circuit does not cause all of the power to the entire premises to be switched-off.

Modern consumer units are mostly fitted with miniature circuit breakers (MCBs), which isolate the respective circuit in the case of an overload or short-circuit. Earth leakage protection may be provided by way of a Residual Current Device (RCD) mounted upstream of the MCBs. The RCD trips in the event of an earth leakage fault and disconnects all downstream circuits in the event of such happening. In order to prevent all circuits being disconnected in the event of an earth leakage fault on a single circuit, certain circuits could be provided with an RCBO circuit protection device, which provides overcurrent, short-circuit and earth leakage protection for a given circuit independently of other protection devices within the consumer unit. Other types of protection device are available, such as arc fault devices (AFDDs).

When an electrical fault occurs, be that an overcurrent, a short-circuit, an arc, or an earth leakage fault, the affected circuit is isolated by the relevant circuit protection device or devices within the consumer unit. In practical terms, most MCBs, RCDs, AFDDs or RCBOs have a switch lever on the front of them, which is typically moved up for “on” and down for “off”. In most cases, a fault will be apparent almost immediately, for example, because all the lights in a property switch off, or all the sockets power-down. In such a situation, the fault is readily-detected and remedial action can be taken straight away.

However, in the case of other types of circuit, for example, outbuilding, garage or rarely-used circuits, or consumer units in offices or at remote locations, the tripping of an MCB or RCBO may go undetected for quite some time because there is no immediately apparent effect. Unless the user regularly checks the consumer unit for the down/off switch positions of the circuit protection devices, then a fault may go undetected for some considerable time. For example, a freezer plugged into a garage socket supplied via a dedicated “garage socket” MCB or RCBO within the consumer unit may be tripped and this may not be detected for several days or even weeks—until such time as a person goes into the garage to take an item from the freezer. However, by that stage, the freezer may well have defrosted ruining its contents, but if the fault were known about sooner, then remedial action could have been taken. The same is true for other types of circuit, such as those providing power to security systems, outbuildings and lofts, etc.—whereby an electrical fault causing an MCB, RCD, AFDD or RCBO to trip may not be detected for some considerable time.

Many appliances are fitted with alarm systems that warn in the event of a malfunction. For example, if a freezer temperature goes above a certain threshold value, then an audible alarm may be emitted by the freezer, which alerts the user to, for example, an ajar door. This is all very well provided power is being provided to the freezer. However, in the event of a power outage or a protection device tripping, there is no power to the freezer and hence no alarm can be emitted.

A need therefore exists for a solution to one or more of the above problems, which the present invention aims to provide.

Aspects of the invention are set forth in the appended independent claim or claims. Preferred and/or optional features of the invention are set forth in the appended dependent claims.

Using a non-contact switch position sensor avoids any possibility of the circuit protection device trip detector affecting, or interfering with, the normal operation of any of the circuit protection devices.

The non-contact switch position sensor suitably comprises a proximity or a break-beam sensor. This may be embodied by a light emitter, which is arranged to emit a beam of light along a line corresponding to the position where any one or more of the switches of the adjacent circuit protection devices would be when in an off position. The light emitter can be coupled with a light detector for detecting the beam, the light detector suitably being located on an opposite side of the circuit protection devices being monitored to the light emitter. Additionally or alternatively, the light emitter and light detector may be located side-by-side. For a break-beam sensor, a reflector can be position on an opposite side of the circuit protection devices being monitored to the light emitter and detector, such that when a device moves to an “off” position, the beam is broken. For an optical proximity sensor, the reflector is not necessary as this type of detector measures the proximity of a reflection surface, being in this case, an “off” position switch toggle, which then indicates an alarm.

The optical proximity or beam-break sensor is suitably arranged such that when any one or more of the switches of the adjacent circuit protection devices being monitored moves to an off position, the beam is interrupted or reflected between the light emitter and the light detector, thereby triggering an alarm.

Preferably, the light emitter comprises a low-power consumption and/or high-intensity light emitter, such as an LED. The light detector may comprise an LDR or photodiode. An LDR or photodiode conveniently has an output that is dependent on the intensity of the light of a given wavelength falling on it, and thus a beam present/beam absent signal can be produced thereby. To avoid emitting visible light and/or the device's operation being affected by ambient lighting conditions, the light emitter suitably comprises an IR or UV LED, and the LDR or photodiode suitably comprises an IR or UV-sensitive LDR or photodiode.

In certain embodiments, the light emitter is incorporated into the main body, and the light detector is located on an opposite side of the one or more adjacent circuit protection devices to be monitored, or vice-versa. In another embodiment, the light emitter emits light in two or more directions, and this means that it can be placed between circuit protection devices to be monitored, rather than to one side thereof. In such embodiments, the circuit protection device trip detector has a light emitter arranged to emit a first beam of light along a line corresponding to the position where any one or more of the switches of the adjacent circuit protection devices located to one side of the circuit protection device would be when in an off position and to emit a second beam of light along a line corresponding to the position where any one or more of the switches of the adjacent circuit protection devices located on an opposite side to the first side of the circuit protection device would be when in an off position, the circuit protection device thus comprising respective light detectors located on opposite sides of the respective one or more adjacent circuit protection devices to be monitored.

In other embodiments, the circuit protection device trip detector has a light emitter and a light detector incorporated into the main body, and it further comprises a reflector arranged to reflect the beam back to the light detector, the reflector being located on an opposite side of the one or more adjacent circuit protection devices to be monitored. Additionally or alternatively, the light emitter is arranged to emit a first beam of light along a line corresponding to the position where any one or more of the switches of the adjacent circuit protection devices located to one side of the circuit protection device would be when in an off position and to emit a second beam of light along a line corresponding to the position where any one or more of the switches of the adjacent circuit protection devices located on an opposite side to the first side of the circuit protection device would be when in an off position, the circuit protection device comprising one or more light detectors located adjacent the light emitter or emitters; and the circuit protection device further comprising respective light detectors located on opposite sides of the respective one or more adjacent circuit protection devices to be monitored for reflecting the respective emitted beams back towards the respective light emitter.

Where provided, the reflector may comprise a retroreflector, which is advantageous as it reduces or eliminates the need for accurate alignment of the reflector relative to the light emitter and reflector. The reflector could simply comprise a strip of self-adhesive retroreflective, or UV-retroreflective tape, which may be affixed to a suitable support to align it with the circuit protection devices being monitored.

The circuit protection device trip comprises a power sensing circuit, which is designed to detect power outages or disconnection of the power supply (e.g. by an RCD or master breaker tripping) from the circuit protection devices being monitored. In one embodiment, the power sensing circuit comprises a voltmeter wired in parallel with the line and neutral connections, and the processing device can be adapted to detect when the voltage across the line and neutral connections drops below a threshold value. In another embodiment, the power sensing circuit comprises a logic circuit held in a first state when a voltage greater than a threshold value is present across the line and neutral connections, but which changes to a second state when the voltage across the line and neutral connections drops below a threshold value, the processing device being configured, in use, to trigger the alarm when the logic circuit changes from the first state to the second state.

The alarm unit suitably comprises any one or more of: a visible light emitter (e.g. a lamp, an LED, a neon, etc.); a sound emitter (e.g. a buzzer, a speaker, a beeper etc.); and a wireless transmitter (e.g. an RF transmitter, a Bluetooth® transceiver, a Wi-Fi transceiver, a GSM module, etc.) adapted, in use, to emit a visual, audible and radio frequency signal, respectively, when the processing device causes the alarm unit to emit an alarm.

A wireless receiver module may optionally be provided, for example in the form of a key fob-type device or a mobile phone where a GSM module is used, which comprises a wireless receiver that receives a wireless signal from the aforesaid wireless transmitter or a wireless network to which it is connected. The wireless receiver module suitably has a processor that is adapted to cause either or both of a visible light emitter, a sound emitter of the wireless receiver module to emit a visible or audible alarm respectively upon the receipt, by the wireless receiver, of the radio frequency signal from the wireless transmitter.

Preferably, either or both of the circuit protection device trip detector and the wireless receiver module (where provided) comprises a push button, which when pressed, performs any one or more of the functions from the group comprising: testing the operation of the circuit protection device trip detector; testing a wireless connection between the circuit protection device trip detector and the wireless receiver module; wirelessly pairing the circuit protection device trip detector to the wireless receiver module; muting an alarm of the circuit protection device trip detector; and muting an alarm of the wireless receiver module.

In certain embodiments of the invention, the main body portion comprises a clip formation for connecting to a DIN rail of the consumer unit and/or the main body portion is shaped and sized to as to occupy a single way of the consumer unit. This enables the circuit protection device trip detector to be readily installed in a consumer unit and to further facilitate this, the line and/or neutral terminals comprise screw terminals that are compatible with other wiring and/or comb busbars within a typical consumer unit. Alternatively, the device is accommodated on or within the consumer unit housing so as to not occupy a way of the consumer unit, which can be advantageous where the number of available ways/modules of a consumer unit is limited.

In order that the circuit protection device trip detector can operate even when the mains power suffers an outage or is disconnected, an uninterruptible power supply is provided. The UPS suitably comprises a step-down power converter, e.g. a transformer and/or a Buck converter, a rectifier and a power storage device, such as a capacitor, or a rechargeable battery. An optional battery charging circuit may be provided. In other words, the UPS suitably comprises a mains AC (e.g. 220 VAC, 50 Hz) to DC (e.g. 5 VDC) converter connected to DC input terminals of a rechargeable battery (via a charging control circuit). The DC output terminals of the rechargeable battery are then suitably connected to power input terminals of the circuit of the circuit protection device trip detector.

Embodiments of the invention shall now be described, by way of example only, with reference to the accompanying drawings in which:

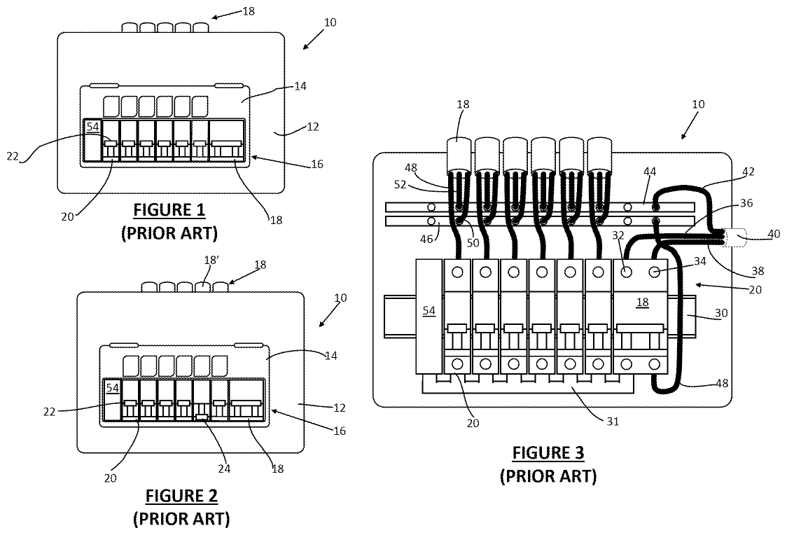

FIG. 1 is a schematic front view of a known consumer unit in a normal/operational state;

FIG. 2 is a schematic, front view of the consumer unit of FIG. 1, albeit with one circuit in a fault/tripped state;

FIG. 3 is a schematic, internal view of the consumer unit of FIG. 1 illustrating the basic wiring arrangement;

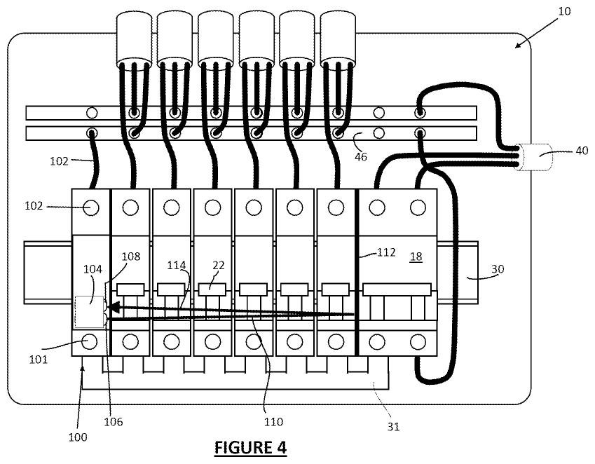

FIG. 4 is a schematic, front view of the consumer unit of FIG. 3, albeit with an embodiment of a trip detection device in accordance with the invention fitted;

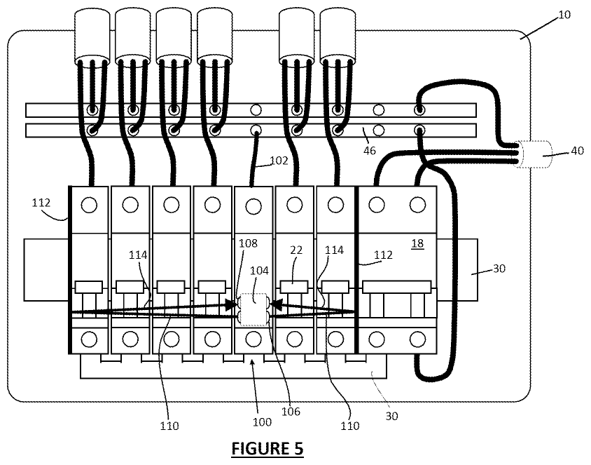

FIG. 5 is a schematic, front view of the consumer unit of FIG. 3, albeit with a second embodiment of a trip detection device in accordance with the invention fitted;

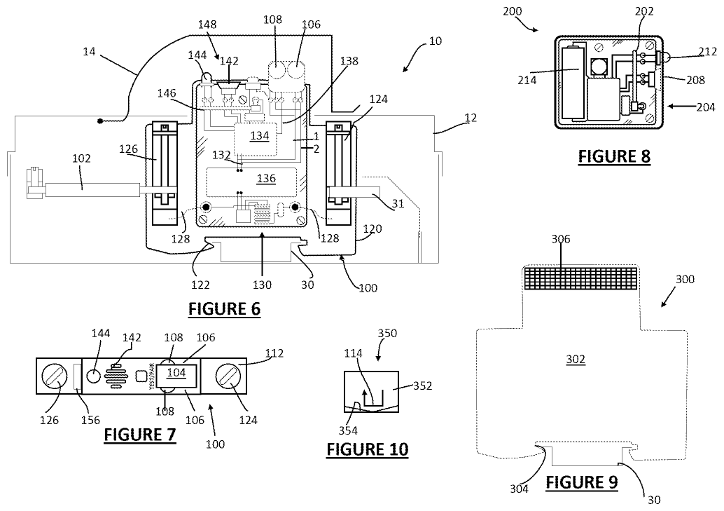

FIG. 6 is a schematic, internal view of an embodiment of a trip detection device in accordance with an embodiment of the invention;

FIG. 7 is a schematic, front view of the trip detection device of FIG. 6;

FIG. 8 is a schematic view of a receiver for use in conjunction with the trip detection device shown in FIG. 6;

FIG. 9 is a schematic, side view of a reflector plate for use in conjunction with the trip detection device shown in FIG. 6;

FIG. 10 is a schematic, additional reflector fitting for the trip detection device described herein;

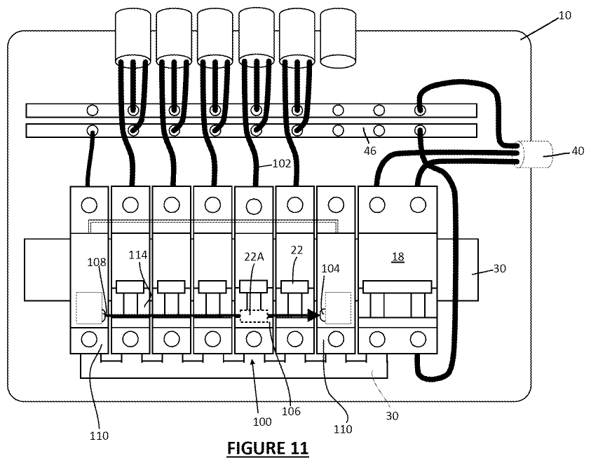

FIG. 11 is a schematic view of an embodiment of the invention, which uses a break-beam sensor with the transmitter and receiver located at opposite sides of the devices being monitored;

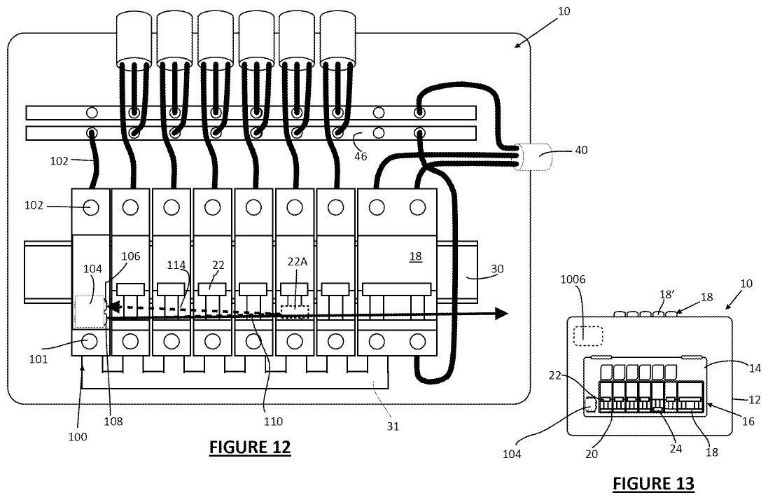

FIG. 12 is a schematic view of an alternative embodiment of the invention, which uses an optical proximity sensor located to one side of the devices to be monitored;

FIG. 13 shows an alternative embodiment to that shown in FIG. 12 where the proximity sensor is located off the DIN rail; and

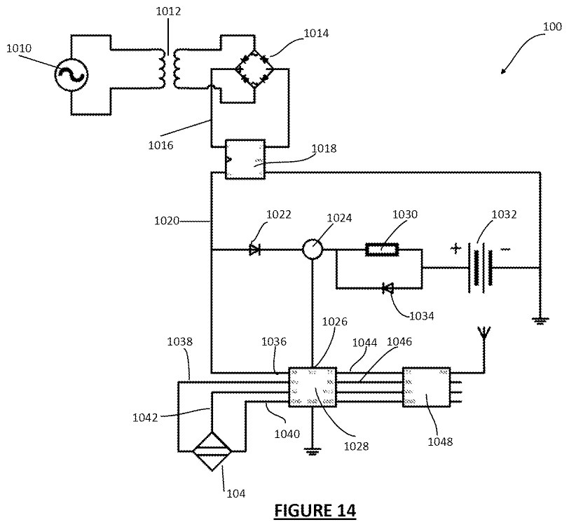

FIG. 14 is a schematic circuit diagram for an embodiment of the invention.

Referring to FIGS. 1 and 2 of the drawings, a known single-phase domestic consumer unit 10 comprises an outer housing 12 and a flip-up cover 14, which covers an array of circuit protection devices 16. Each circuit protection device 16 provides an electrical connection for a respective discrete circuit, known as a “way”, which emerges as cabling 18 from one side of the housing 12. The circuit protection devices 16 generally comprise a double-pole master isolator 18, which is capable of disconnecting the phase and neutral conductors completely from the supply; whereas the remaining MCBs or RCBOs 20 are generally single-pole protection devices corresponding to each way 18.

The normal operation of the consumer unit 10 sees all of the trip switches 22 for the MCBs 20 in an “up” or “on” position—as shown in FIG. 1. However, in the event of a fault, for example, on circuit 18′ the respective protection device 24′ trips causing its switch to move to a “down” or “off” position as shown in FIG. 2. This results in the connected circuit 18′ ceasing to receive power from the consumer unit 10, and this results in the lights, sockets or other devices of that circuit 18′ being powered-down. In the case of lighting or sockets, this is usually readily apparent and remedial action can be taken, which usually involves, in the first instance, resetting the tripped switch 24′, but if that is not effective, carrying remedial works on the affected circuit 18′.

Visual inspection of the circuit protection device 16 is possible by virtue of the cover 14 typically being manufactured from a transparent material, or at the very least, being readily openable so as to permit inspection of the circuit protection devices 16.

Internally, the consumer unit 10 comprises a DIN rail 30, to which the circuit protection devices 20 are clipped. The double-pole isolator 18 has line 32 and neutral 34 connectors, which connect, respectively, to the line 36 and neutral 38 conductors of an incoming power cable 40 or meter tails. The circuit protection conductor 42 (CPC or “earth cable”) connects to an earth bus bar 44 inside the consumer unit 10. The master circuit breaker 18 has a line output), which electrically connects to the line bus bar 31 (typically a copper “comb”), and the neutral terminal 34 connects to a neutral bus bar 46 via a fly lead 48. Thus, the master breaker 18 is able to connect or isolate both of the line 36 and neutral 38 incoming power conductors from the entire circuit, as the case may be.

Each of the individual MCBs or RCBOs 20, receive their line power via respective terminals clamped (not visible) to the projections of the comb line bus bar 31, and a line fly lead 48 connects to the line conductor of a given way 18. Meanwhile, the neutral conductor 50 of the ways 18 connects to the neutral bus bar 46, and the circuit protection conductor 52 of each way 18 connects to the CPC bus bar 44. This arrangement will be well understood by persons skilled in the art. However, it will be appreciated that the illustration shown in FIG. 3 is merely schematic, and other variations are possible. For example, it is commonplace to split the line bus bar 31 so as to form a “split load” consumer unit whereby each of the bus bar portions has its own power supply and circuit protection devices fitted.

It can be seen, from FIGS. 1, 2 and 3 that a blanking plate 54 or dummy RCB has been fitted to blank an unoccupied way.

In FIGS. 4 and 5 of the drawings, a trip detection device 100 in accordance with the invention has been fitted at an unoccupied way of the consumer unit 10. The trip detection device 100 is clipped to the DIN rail 30 in the same manner as the other circuit protection devices 18, 20. A screw terminal 101 connects it to the line bus bar 31, and a fly lead 102 extends from a neutral screw terminal 103, to the neutral bus bar 46. The trip detection device 100 is therefore powered off the mains supply 40 in a manner that would be easily understood by the skilled reader.

The trip detection device 100 has an outwardly protruding body member 104, which houses a light emitter 106 and a light detector 108. The light emitter 106 emits a beam of light 110 along the width of the consumer unit 10 at a position corresponding to the “down” or “off” position of each of the trip switches 22. A reflector 112 is fitted into the consumer unit 10 either between two circuit protection devices, or at the end of a row of circuit protection devices 20. The reflector 112 causes the transmitted beam 110 to be reflected back 114 towards the light detector 108, where it is detected.

As can be seen in FIGS. 4 and 5, all of the trip switches 22 are in the “up” or “on” position and so the transmitted 110 and reflected 114 beams are uninterrupted. The light detector 108 therefore detects the light or other radiation emitted from the light emitter 106, and this indicates normal operation. However, it will be appreciated that should any of the trip switches 22 move into the “down” or “off” or “tripped” position, either or both of the transmitted 110 or reflected 114 beams will be interrupted (because the trip switch 22 moves into the path of the light beams), and therefore the light detector 108 will cease detecting the beam 110 emitted by the light emitter 106. This will indicate an alarm situation.

The advantage of using a light beam, an IR beam, or some other form of irradiation to detect the position of the switches 22 is advantageous because it is contactless. There is thus no possibility of a mechanical device such as a microswitch affecting, in any way, the normal operation of the circuit protection devices 20. If a physical device, such as a micro-switch, were to be used to detect positional changes of the trip switches 22, then there is a finite possibility that this may adversely affect the normal operation of the circuit protection devices. The present invention, by using a contactless means of detecting the position of the trip switches 22 avoids any possibility of interfering with the normal operation of the circuit protection devices 20. The invention also avoids adding or removing any wiring to the circuit protection devices 20 being monitored.

FIG. 5 illustrates an embodiment having a double-sided light emitter 106 and detector 108 and a pair of reflector plates 112. This enables the trip detector 100 to be positioned mid-way in a run of CPDS to be monitored.

Referring now to FIG. 6 of the drawings, it can be seen that the trip detection device 100 comprises a main body 120, which has substantially the same shape and dimensions as a conventional circuit protection device 20. It has a clip formation 122 on its rear surface, which engages with the DIN rail 30 previously described. A screw terminal 124 is provided so as to tap power from the phase bus bar/DIN rail 31. The neutral fly lead 102 fits into a terminal socket 126 and is clamped into electrical connection by a grub screw as will be well understood by the skilled reader.

Internal electrical connections 128 connect the mains power supply 124/126 to a rectifier/step-down device 130 located within the main body 120. The rectifier/step-down device 130 rectifies the incoming AC power supply into a usable DC voltage (eg 6 VDC) and outputs a DC voltage via connectors 132 into a CPU 134. The CPU 134 is thus powered by the power conditioning device 130 in a manner that is easily understood by the skilled reader.

An uninterruptable power supply (UPS) 136 is also provided, which contains a charge circuit and a battery/accumulator for storing DC power. Thus, in the event of the mains power 124 becoming disconnected, the CPU 134 can receive its power from the UPS 136 and still continue to function.

The CPU 134 has several I/O connectors. Terminals 1 and 2 provide DC power to the transmitter 106, which may be an LED emitting visible and/or infra-red or ultra violet light. A corresponding receiver/detector 108 is also provided, and that too is powered by terminals 1 and 2. The receiver/detector 108 has a signal line 138, which connects to a terminal of the CPU 134. In the event of the beam 110, 114 being broken, the detector/receiver 108 emits a signal via signal line 138, which is processed at the CPU 134. The detection of a “beam break” signal indicates an alarm condition, and an alarm signal is then outputted. The alarm signal triggers an audible and/or visual and/or RF alarm, which can be emitted by a speaker/buzzer 142, an LED 144 and an antenna 146, respectively, of an alarm unit 148. The alarm unit 148 also takes its power from the UPS 136, and can thus function even when the trip detection device 100 is disconnected from the mains power supply 124.

It will be appreciated, that in the event of a beam break detection, indicating the movement of a trip switch 22 from the “on” to “off” position, that an alarm signal is generated by the CPU 134 and this triggers the alarm unit 148 to move into an operational mode. A high-intensity flashing LED 144 is used, and/or a buzzer/speaker 142 to emit visual and audible alarms, respectively. The antenna 146 also emits a wireless signal, which can be detected, in certain embodiments, by a receiving device 200, such as shown in FIG. 8, and which will be described in greater detail later.

In addition to the foregoing, a voltage detection device is also provided within the trip detection device 100, which measures the voltage between the line 124 and neutral 126 terminals thereof. Under ordinary conditions, there will be a mains voltage potential between the line 124 and neutral 126 terminals, but in the event of a power outage, or the master circuit breaker 18 being tripped or switched off, then this voltage will drop to zero. The voltage detection device has a signal cable, which connects to a terminal of the CPU 134. In the event of a power interruption, the signal at the said terminal of the CPU 134 can also be used to trigger an alarm, which is also output via the signal line to the alarm unit 148.

As can be seen from FIG. 7 of the drawings, the LED 144 and speaker 142 are provided on the front surface of the circuit protection device's main body 120 so as to be easily visible and/or audible, in use.

Also shown in FIG. 7 is a SIM card slot 156, into which a mobile telephony SIM card can be inserted. This enables the wireless signal emitted by the antenna 146 to be a SMS or telephone message, which can be received by any compatible telephone or mobile phone device. Additionally or alternatively, the alarm module 148 may comprise a WiFi transceiver, which emits a wireless signal 150, via WiFi, to a connected device, such as a computer, smartphone, tablet or the like.

It will thus be appreciated that an alarm can be “physical” in the sense of being in the form of a flashing light and an audible beep; or it could be a wireless signal, which can be detected by WiFi, a dedicated receiver 200 or by another device, such as a smartphone, tablet, computer or mobile phone.

The receiver 200 shown in FIG. 8 of the drawings also comprises an antenna 202, which is connected a receiver alarm unit 204. Upon receipt of the wireless alarm from the trip detector 100 signal, the receiver alarm module 204 moves into operation, and emits an audible alarm signal 206 via a built-in speaker 208 and/or a visual alarm signal 210 via a built-in LED or the like 212. The receiver 200 is powered by a rechargeable battery 214 and this enables it to operate independently of the mains power supply, which may have tripped.

As previously described, the trip detection system 100 works by detecting a reflected beam. In certain embodiments of the invention, two trip detection devices may be provided—at opposite ends of a span of circuit protection devices—one having a transmitter 106 and the other having a receiver 108. This avoids the need to have to use reflectors or to rely on reflected beams. However, this arrangement does occupy two ways of a consumer unit 10, and is thus less optimal.

Referring now to FIGS. 9 and 10 of the drawings, various reflectors 300, 350 are shown. The first reflector, shown in FIG. 9 is a planar reflector device 300, which comprises an electrically insulative main body 302, which comprises a recess 304 that clips on to the DIN rail 30 previously described. The thickness of the main body 302 is thin enough to fit into a small gap between adjacent circuit protection devices 20, or between the body 12 of the consumer unit 10 and a circuit protection device 20. The main body is manufactured from plastics or other electrically insulative materials, so as to avoid forming a touchable electrical contact within the consumer unit.

At least part of reflector 300 comprises a silvered, reflective or retro-reflective surface element 306. This protrudes beyond the normal extension of a circuit protection device, and aligns with the transmitter 106 and receiver 108 previously described.

Referring to FIG. 10 of the drawings, a reflector cup 350 comprises a hollow plastics body 352, which is a clip fit onto the protrusion 104 previously described. Internally, it comprises a reflective surface 354, which is generally V-shaped or curved so as to reflect light from the transmitter 106 to the receiver 108 on an unused side of the trip detection device 100. The clip-on reflector 350 can be fitted over the protrusion 104 in either direction and this means that the transmitted beam 110 emerges from one side only of the trip detection device 100. The mirrored surface 354 provides an internal reflected beam 114 such that the receiver 108 always receives a reflected beam from that side of the trip detection device 100. This obviates the need to fit a plate reflector 300 on that side of the trip detection device 100, and also enables it to be used at either end of a row of circuit protection devices 20. However, with the clip-on cover 350 removed, beams 110 are emitted from both sides of the trip detection device 100, and this means that it can be installed at any location of the consumer unit (as shown in FIG. 5), albeit with a plate reflector 112 at either end of the row.

Referring now to FIG. 11 of the drawings, a trip detection device 100 is shown which has separate modules 1002, 1004 fitted to the DIN rail 30 of the consumer unit 10. The modules to be monitored are interposed between the transmitter module 1002 and the receiver module 1004 with an infrared emitter 108 aligned with an infrared receiver 104 and also the toggle switches 22 when in the “off” position. As can be seen from FIG. 11 of the drawings, when all of the toggle switches 22 are in the “on” or up position, the infrared beam 110 between the transmitter 108 and receiver 104 is uninterrupted. However, if one of the toggle switches moves to an “off” or down position, as indicated by dash line 22A, the beam 110 is interrupted and the IR receiver 104 ceases to pick up the beam's signal. This indicates a fault condition and an alarm can be sent.

Referring to FIG. 12 of the drawings now, an infrared proximity sensor 104 is used with the transmitter 108 and the receiver 106 located in the same housing 104. Here, when the beam 110 is uninterrupted, with the toggle switches in the “on” or up position, there is no reflected signal 114 and so this indicates a no-fault condition. However, if one of the switches moves to the “off” position as shown by dash line 22A, the beam 110 is reflected 114 back to the receiver 106, and this indicates a fault condition.

The advantage of using a reflected beam sensor is that it only occupies one way of the consumer unit and therefore takes up that space. In addition, by using a time-of-flight optical reflection sensor, it is possible to determine from the analogue signal received by the receiver 106, the location of the tripped circuit protection device. Typically, the analogue of the receiver 106 follows an exponential decay function, so the value of the reflected signal is a function of the distance between the transmitter 108 and the tripped toggle switch 22A. By interpreting the analogue output of the optical proximity sensor, it is possible not only to detect whether a circuit protection device has tripped, but also which circuit protection device has tripped.

For the sake of completeness, a yet further alternative embodiment is shown, which is functionally equivalent to that shown in FIG. 12, except this time, the optical proximity sensor 104 is located off the DIN rail and is integrated into the main body 12 of the consumer unit 10. This means that the system does not require any space on the DIN rail 30, thus increasing the usable capacity of the consumer unit. In this case, a control module housing 1006 can be provided within the consumer unit housing 12 at a convenient location, which is connected to the optical proximity sensor 104 by fly leads (not shown).

Referring now to FIG. 14 of the drawings, a schematic circuit diagram is shown for the embodiment of the invention described in relation to FIGS. 12 and 13. Here, the trip detector 100 is powered by a mains AC power supply 1010, which is, in practice, a feed from the line bus bar 31 as previously described. The AC input 1010 feeds into a step-down transformer 1012 and then passes through a bridge rectifier 1014, which outputs an appropriate DC voltage 1016. Suitably, the transformer 1012 and the rectifier/voltage regulator 1014 are integrated into a single component, such as an ultra-miniature embedded switch mode power supply (such as a Mornsun L503-15B-95R2 mains to 9 VDC SMPS). The DC voltage is, for example, 9 volts DC and this input voltage 1016 is optionally further regulated using a voltage regulator I/C 1018 (such as an ST Microelectronics L8705ACV). The output of the voltage regulator is a constant DC voltage, such as 5 VDC 1020, which is used to power the remainder of the circuit. The 5 VDC power supply 1020 feeds, via a diode 1022, into a node 1024. When an AC voltage 1010 is present, the 5 VDC power supply 1020 feeds directly to the Vcc input 1026 of a microcontroller, such as Arduino device (e.g. ATmega328P 5V 16 mhz).

In addition, the node 1024 is connected to a resistor 1030, which trickle charges a backup battery 1032. The value of the resistor 1030 is selected to have a value that is suitable for trickle charging the battery 1032. Typically, this is 1/300 of the rated capacity of the battery, for example, to provide a 10 mA charging current for a typical 9 volt PP3 battery. Whilst voltage 1020 is present, the battery 1032 trickle charges via the resistor 1030.

However, in the event of a power outage at the AC input 1010 or the DC output 1020, power from the battery 1032 is shunted to the node 1024 via a further diode 1034. This is, of course, the path of least resistance compared with the resistor path 1030, and so the battery 1032 discharges to the node 1024, which in turn feeds power to the Vcc terminal 1026 of the microcontroller 1028. Power from the battery 1032 cannot be fed back up to the power regulator 1018 due to the presence of the first diode 1022, which is now reverse-biased. It will be appreciated that this provides a relatively straightforward UPS arrangement.

The microcontroller 1028 is suitably an Arduino nano or Arduino nano pro type device, which provides adequate functionality at a low cost and small physical footprint. One of the analogue inputs 1036 of the microcontroller 1028 is connected to the incoming power 1020 and so it is possible to use a routine/sketch within the Arduino programming language to detect whether the microcontroller 1028 is being powered by the mains power supply 1010/1020 (V at pin 1036 high); or by the backup power supply 1032 (V at pin 1036 low). In other words, if the analogue voltage at pin 1036 drops to 0, this indicates a power outage and/or use of the UPS. A routine within the program for the microcontroller 1028 can thus trigger an alarm.

In addition, an optical proximity sensor 104, such as a sharp GP2Y0A41SK0F analogue distance sensor module is provided to detect the tripping of monitored circuit protection devices. Here, the proximity sensor 104 is powered by an internal Vcc 1038 pin of the microcontroller 1028 and an internal/common ground pin 1040. The analogue output 1042 of the proximity sensor 104 is connected to a further analogue input pin of the microcontroller 1028.

If the microcontroller is programmed to interpret the value of the analogue output 1042 of the microcontroller 104, via a built-in ADC, it is possible to detect tripping of circuit protection devices, as well as the location of the tripped circuit protection device.

Upon detection of either alarm state (be that power outage or trip), a signal is used to alert a user. In the embodiment shown in FIG. 14, the serial TX 1044 and RX 1046 pins of the microcontroller 1028 are connected to respective TX and RX pins of a GSM module 1048, such as a SIM800L module, which is relatively inexpensive and readily available. The GSM module 1048 is also powered by the microcontroller 1028 Vcc and common ground outputs, or via a dedicated power supply, such as a buck converter.

Although not shown in FIG. 14 for clarity, an output pin of the microcontroller 1028 can be configured to output a signal upon detection of an alarm state, which powers an LED and/or a buzzer. Preferably, the location of the tripped breaker triggers different alarm states, such as a sequence of 5 beeps and/or flashes where breaker 5 is tripped, a sequence of 3 beeps and/or flashes where breaker 3 is tripped, etc. This facilitates identifying, without having to open the consumer unit, which of the breakers has tripped.

Preferably, upon receipt of an alarm, the microcontroller 1028 can be configured to output AT commands via its serial output pins 1044, 1046 thus causing the GSM module 1048 to autodial a phone number and/or send a preformatted SMS text message to a designated number.

A further advantage of using a GSM module 1048 is that it is also possible to send configuration settings to the microcontroller 1028 via SMS messages. This greatly facilitates the configuration of the trip detector 100 as it is possible, for example, to assign a location name, way names, etc. to customise the configuration.

For example, sending an SMS message “CFGLOC HOME”, could configure the microcontroller to append the word “HOME” to all outgoing messages such that upon receiving an SMS message, it is immediately obvious which consumer unit has had an alarm condition. Likewise, it is possible to name the ways, for example by using “CFGWO1 downstairs sockets” to tag way one of the consumer unit to “downstairs sockets”. In such a situation, if the downstairs sockets trip, then an SMS message can be sent to a user which reads “Downstairs sockets tripped at home”. Various combinations and permutations of configuration settings are easily envisaged.

Incoming SMS messages can also be used to configure the physical/calibration settings of the microcontroller, such as the spacing between the break-beams sensor and the first toggle switch (“CFGOFS 30”=30 mm offset); the number of toggle switches to be monitored (“CFGNUM 6”=6 modules to monitor) thus ignoring any trip events outside the selected range; the spacing between the toggle switches (“CFGSPC 18”=18 mm module spacing) in case non-standard 18 mm modules are used.

The configuration settings and other parameters are suitably stored in non-volatile memory of the microcontroller, such as within the EEPROM of an Arduino device. This means that the microcontroller restores to the pre-saved settings on power-up, although it will be appreciated that generic/standard default names and settings are preferably pre-programmed into the device for first use, which facilitates “out of the box” operation for most standard installations.

The invention is not restricted to the details of the foregoing embodiments, which are merely exemplary of the invention.

1. A circuit protection device trip detector comprising:
a main body;
a line terminal electrically connectable, in use, to a line busbar of a consumer unit;
a neutral terminal electrically connectable, in use, to a neutral busbar of the consumer unit; and
a circuit within the main body powered by the line and neutral connections to the line and neutral terminals, respectively, wherein:
the circuit comprises:
an uninterruptible power supply powered by the line and neutral connections;
a power sensing circuit for sensing a voltage at the line busbar;
a non-contact, optical switch position sensor for detecting the switch position of any one or more circuit protection devices within the consumer unit;
an alarm unit; and
a processing device that is powered by the uninterruptible power supply and which has a first input connected to the power sensing circuit, a second input connected to the switch position sensor; and an output connected to the alarm unit, the processing device being adapted, in use, to detect an alarm situation being:
a drop or loss of voltage at the line busbar; and
a change in a switch position of any one or more of the circuit protection devices; and to cause the alarm unit to emit an alarm upon detection of either or both of the said alarm situations.

2. The circuit protection device trip detector of claim 1, wherein the non-contact, optical switch position sensor comprises an optical time-of-flight sensor comprising a light emitter and a light detector located adjacent the monitored circuit protection devices within the consumer unit such that when the toggle switch of any one of the monitored circuit protection devices are in an “off” position, a beam from the light emitter is reflected off the said toggle switch towards the light detector, the reflected beam being detectable as a change in an output of the light detector.

3. The circuit protection device trip detector of claim 1, wherein the a non-contact, optical switch position sensor comprises a break-beam sensor comprising a light emitter and a light detector arranged on opposite sides of the monitored circuit protection devices within the consumer unit, the beam between the light emitter and the light receiver being uninterrupted when the toggle switches of the monitored circuit protection devices are in an “on” position, and the beam between the light emitter and the light receiver being interrupted when any one or more of the toggle switches of the monitored circuit protection devices are in an “off” position, the interruption being detectable by a change in an output of the light detector.

4. The circuit protection device trip detector of claim 1, wherein the processing device is adapted to cause the alarm unit to emit an alarm upon detection of a change in an output of the light detector.

5. The circuit protection device trip detector of claim 2, wherein the magnitude of the output of the light detector is a function of the distance between the light emitter and the toggle switch of the monitored circuit protection device that is in the “off” position.

6. The circuit protection device trip detector of claim 5, wherein the processing device is adapted to cause the alarm unit to emit one of a set of different alarms upon detection of a change in an output of the light detector, the selected one of the different alarms being dependent on the magnitude of the output of the light detector, and hence which of the toggle switches has been moved to the off position.

7. The circuit protection device trip detector of claim 2, wherein the light emitter comprises an infra-red LED and wherein the light detector comprises an infra-red sensitive LDR or photodiode.

8. The circuit protection device trip detector of claim 1, wherein the alarm unit comprises a mobile telephony transceiver.

9. The circuit protection device trip detector of claim 8, wherein a processing device comprises a microprocessor connected to the mobile telephony transceiver via a data connection.

10. The circuit protection device trip detector of claim 9, wherein the data connection comprises one-way or two-way AT commands over a serial data connection.

11. The circuit protection device trip detector of claim 8 or claim 9, wherein the mobile telephony transceiver is configured to receive incoming SMS messages and to transmit said messages to the microprocessor, the microprocessor in turn being programmed to parse the incoming SMS messages and to extract configuration settings therefrom.

12. The circuit protection device trip detector of claim 8 or claim 9, wherein the microprocessor is programmed to parse alarm signals into human-readable text messages, which are broadcast by the mobile telephony transceiver to a pre-configured telephone number for reading by a user.

13. The circuit protection device trip detector of claim 1, wherein the main body is shaped and sized to as to occupy a way of a consumer unit.

14. The circuit protection device trip detector of claim 1, wherein the main body portion comprises a clip formation for connecting to a DIN rail of the consumer unit.

15. The circuit protection device trip detector of claim 1, wherein the main body comprises a push button, which when pressed, performs any one or more of the functions from the group comprising: testing the operation of the circuit protection device trip detector; testing a wireless connection between the circuit protection device trip detector and a wireless receiver module; wirelessly pairing the circuit protection device trip detector to the wireless receiver module; muting an alarm of the circuit protection device trip detector; and muting an alarm of the wireless receiver module.
